(19) United States
(12) Patent Application Publication
(10) Pub. No.: US 2025/0045654 A1
(43) Pub. Date: Feb. 6, 2025

(54) SERVICE GROUP PLATFORM CASE ASSIGNMENT SYSTEM AND METHOD THEREOF

(71) Applicant: Charles Lap San CHAN, Taipei (TW)

(72) Inventor: Charles Lap San CHAN, Taipei (TW)

(21) Appl. No.: 18/791,719

(22) Filed: Aug. 1, 2024

(30) Foreign Application Priority Data
Aug. 2, 2023 (TW) 112129118

(51) Int. Cl. G06Q 10/0631

(52) U.S. Cl. CPC G06Q 10/06311

(57) ABSTRACT

The disclosure describes a service group platform case assignment system and a method thereof to increase or decrease the number of service personnel anytime, allow service personnel to actively select service targets, and conveniently request assistance from other service personnel. The service group platform case assignment system includes user device, a backend device, and service devices. Each user device provides an operator user interface for inputting a question category and question information. The backend device, connected to the user devices, provides a service group platform for receiving the question category and the question information. The service devices are connected to the backend device. Each service device provides a service user interface. The service user interface of each service devices displays the question category and the question information. The service user interface of each service device provides checkboxes respectively corresponding to the user devices for establishing a communication connection.

### BACKGROUND OF THE INVENTION

This application claims priority for the TW patent application no. 112129118 filed on 2 Aug. 2023, the content of which is incorporated by reference in its entirely.

### Field of the Invention

The present invention relates to a service group platform case assignment system and a method thereof, particularly to a service group platform case assignment system and a method thereof that can increase or decrease the number of service personnel anytime, allow service personnel to actively select service targets, and conveniently request assistance from other service personnel.

### Description of the Related Art

Today's common online service case assignment systems can provide real-time communication channels on websites or applications, allowing users to interact with service personnel and obtain responses to user questions. Based on general real-time messaging technology, such as web chatting rooms or real-time messaging software, the service case assignment system communicates through message transmission among users, backend devices, and service personnel.

Service case assignment systems are widely used in various industries, including e-commerce, finance, telecommunications, etc. When users need to communicate with a business or a service provider, they can ask questions, seek help, or obtain information through the customer service function on the website or application. This service case assignment system provides a convenient way for users to interact with service personnel instantly to solve problems or provide support.

For example, when consumers shop online, they may need to inquire about product information, inquire about shipping ways, or handle returns and exchanges. Using the service case assignment system, consumers can communicate with merchant service personnel in real time to solve their questions or problems. Alternatively, in various service industries, such as banking, telecommunications, etc., customers may need help with accounts, service plans, payment issues, etc. Traditional service case assignment systems can provide real-time support, allowing customers to easily interact with service providers' service personnel.

However, traditional online service case assignment systems often only assign users' service requests to different service personnel sequentially or randomly. The traditional online service case assignment systems cannot timely adjust the order of assigning users' service requests to different service personnel according to the experience level of the service personnel. In addition, the traditional online service case assignment system cannot easily switch to another service personnel to intervene when the service personnel need further assistance.

In view of this, how to dynamically adjust the method of assigning cases in response to the situations of service personnel in the service case assignment system and how to assist service personnel have become a research direction that those skilled in the art are committed to.

### SUMMARY OF THE INVENTION

The primary objective of the present invention is to provide a service group platform case assignment system and a method thereof that can increase or decrease the number of service personnel anytime.

Another objective of the present invention is to provide a service group platform case assignment system and a method thereof that can allow service personnel to actively select service targets.

Further objective of the present invention is to provide a service group platform case assignment system and a method thereof that can conveniently request assistance from other service personnel.

To achieve the abovementioned objectives, the present invention provides a service group platform case assignment system, which includes:
user devices each providing an operator user interface that is configured to input a question category and question information;
a backend device, connected to the user devices, providing a service group platform that is configured to receive the question category and the question information transmitted by each of the user devices; and
service devices connected to the backend device;
wherein each of the service devices provides a service user interface, the service user interface of each of the service devices displays the question category and the question information of each of the user devices transmitted from the service group platform, the service user interface of each of the service devices provides checkboxes respectively corresponding to the user devices, and each of the checkboxes is used to establish a communication connection between the service device and the user device corresponding to the checkbox;
wherein one of the service devices selects one of the checkboxes to establish the communication connection with the user device corresponding to the checkbox and responds to the question information provided by the user device corresponding to the checkbox based on the communication connection.

The present invention provides a service group platform case assignment method applied to a service group platform case assignment system that includes user devices, a backend device, and service devices, each of the user devices providing an operator user interface, each of the service devices providing a service user interface, and the service group platform case assignment method including:
Step (A): adding the user devices and service devices to a service group platform provided by the backend device;
Step (B): by each of the user devices, inputting a question category and question information through the operator user interface;
Step (C): by the service group platform, receiving the question category and the question information transmitted by each of the user devices;
Step (D): by the service group platform, transmitting the question category and the question information of each of the user devices to each of the service devices;
Step (E): by the service user interface of each of the service devices, displaying the question category and the question information of each of the user devices transmitted from the service group platform;
Step (F): by the service user interface of each of the service devices, providing checkboxes respectively corresponding to the user devices, wherein each of the checkboxes is used to establish a communication connection between the service device and the user device corresponding to the checkbox; and
Step (G): by one of the service devices, selecting one of the checkboxes to establish the communication connection with the user device corresponding to the checkbox and responding to the question information provided by the user device corresponding to the checkbox based on the communication connection.

The features, advantages, or similar expressions mentioned in the specification do not mean that all the features and advantages that can be realized by the present invention should be in any single specific embodiment of the present invention. Rather, it should be understood that the expression of related features and advantages means that the specific features, advantages, or characteristics described in conjunction with specific embodiments are included in at least one specific embodiment of the present invention. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating service devices that provide services for user devices of the present invention;

FIG. 2 is a schematic diagram illustrating a service group platform case assignment system according to a preferred embodiment of the present invention; and

FIG. 3 is a flowchart of a service group platform case assignment method according to a preferred embodiment of the present invention.

### DETAILED DESCRIPTION OF THE INVENTION

In order to make the description of the present disclosure more detailed and complete, the following provides an illustrative description for the implementation aspects and specific embodiments of the present invention; but this is not the only way to implement or use specific embodiments of the present invention. The implementation manners cover the characteristics of a number of specific embodiments and the steps and sequences of the method used to construct and operate these specific embodiments. However, other specific embodiments can also be used to achieve the same or equal functions and sequence of steps.

It should be noted that, unless otherwise specified, all functions described herein may be implemented in hardware or used as software instructions that enable a computer to perform predetermined operations, wherein the software instructions are implemented in a computer-readable storage media, such as a random-access memory (RAM), a hard disk drive, a flash memory, or other types of a computer-readable storage media known to those skilled in the art. In some embodiments, the predetermined operations of the computer are performed by a processor, such as a computer, or performed by program codes such as computer program codes or program codes of software or firmware. In some embodiments, the predetermined operations of the computer are performed by integrated circuits encoded to perform these functions. Furthermore, it should be understood that various operations described herein as being performed by a user may be performed manually by the user, or may be automatically performed with or without instructions provided by the user.

The present invention provides a service group platform case assignment system and a method thereof to increase or decrease the number of service personnel anytime, allow service personnel to actively select service targets, and conveniently request assistance from other service personnel.

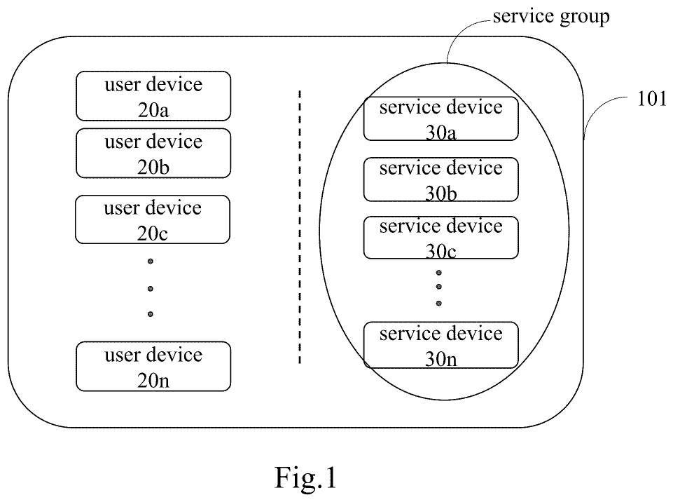

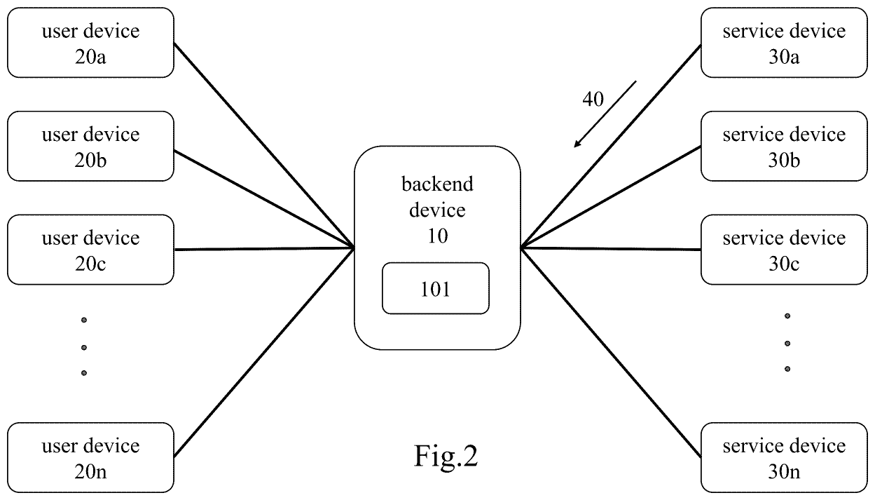

Please refer to FIG. 1 and FIG. 2 for the following description. FIG. 1 is a schematic diagram illustrating service devices that provide services for user devices of the present invention. FIG. 2 is a schematic diagram illustrating a service group platform case assignment system according to a preferred embodiment of the present invention.

The application examples and advantages of the present invention are briefly stated below and will be further described in detail later.

In the present invention, a service group platform 101 is provided by a backend device 10. User devices 20a-20n are connected to the backend device 10. Service devices 30a-30n are also connected to the backend device 10. The user devices 20a-20n and the service device 30a-30n log in to the service group platform 101. In the service group platform 101, if any user device has any questions, it can use a user interface provided by the user device to input a question category and question information. The question category and the question information inputted by any user device will be transmitted to the service group platform 101, then transmitted to all service devices 30a-30n by the service group platform 101, and displayed on the service user interface of each of the service devices 30a-30n. In other words, all service devices 30a-30n can receive the question categories and the question information provided by all user devices 20a-20n. Therefore, the service devices 30a-30n can be regarded as a service group. Any service device in this service group may select any user device and answer the question information provided by the user device. It should be understood that although the question category and question information inputted by any user device are transmitted to all service devices 30a-30n, each user device does not receive the question categories and the question information transmitted to the service group platform 101 by other user devices. Therefore, for a user operating a user device, the user will only feel that he has sent a question to a service group platform 101 and received a suitable response without receiving additional disturbance.

For the service group platform case assignment system of the present invention, the number of service devices can be increased or decreased at any time, making the number of service devices in the service group adaptable. Thus, the system provides users with elastic service capacity. Furthermore, since all service devices 30a-30n in the service group can receive the question categories and the question information inputted by all user devices 20a-20n and display them on their service user interfaces, the service personnel of each service device can actively select user devices corresponding to questions that can be answered based on their own abilities and expertise to establish a communication connection, and then respond to questions provided by the user device based on the communication connection.

In other words, although senior service personnel can answer many types of questions (for example: 3C, beauty, groceries, clothing, etc., or for example: shopping, promotion, payment, logistics, returns, etc.) and more questions in each category, but it takes a long time to develop the senior service personnel and the senior service personnel are not easily developed. In the system of the present invention, even if junior or newly trained service personnel can only handle one or two question categories, they can log in to the service group platform 101 by operating the service device and form a service group with the service devices of other service personnel. The service group provides services for all user devices. In this case, the new junior or newly trained service personnel can deal with the question types and questions they are good at, thereby making a partial contribution to the service capacity. The senior service personnel can deal with the question categories and questions that other junior personnel cannot handle.

In addition, during the communication process between a service device and a user device, if the service personnel operating the service device think that they are unable to respond to the current user's questions well or need the assistance of senior personnel, the service personnel can operate the service device to transmit a transfer request to another service device through the service user interface. The transfer request is used to ask whether another service device agrees to establish a transfer communication connection with the user device. The transfer communication connection is used to allow another service device to replace the original service device in responding to the question information provided by the user device. That is to say, the communication connection is only built between the foregoing another service device and the user device. In another embodiment, the transfer communication connection is used to enable another service device to assist the original service device in responding to the question information provided by the user device. That is to say, the original service device, the foregoing another service device, and the user device communicate with each other.

Please refer to FIG. 1 and FIG. 2 for the following description. Next, the purpose of each device in the system and the functional units thereof will be further described in more detail. The operation process of the system will be further described later. In FIG. 2, the system includes a backend device 10 with software installed therein, n user devices 20a-20n, and n service devices 30a-30n. The n user devices 20a-20n and the n service devices 30a-30n are all connected to the backend device 10. The backend device 10 provides a service group platform 101. The n user devices 20a-20n and the n service devices 30a-30n are independent electronic devices, such as mobile devices, notebook computers, desktop computers, tablet computers, smart phones, etc.

The n user devices 20a-20n are connected to the backend device 10, wherein each user device 20a-20n provides an operator user interface (not shown). The operator user interface is used for the user to input a question category and question information. The question categories can correspond to the services provided by the service provider. The question categories can be divided into categories such as 3C, beauty, groceries, clothing, etc., or can be divided into categories such as shopping, promotion, payment, logistics, returns, etc., but the present invention is not limited thereto. The question information is a question inputted by the user. For example, the user can ask questions about clothing through the operator user interface or ask questions about returns through the operator user interface.

In an embodiment of the present invention, when a user operates a user device to communicate with a service device, the communication connection is used in a text communication mode by default. However, when necessary, the service device can further transmit a request to establish a voice communication connection or a request to establish a video communication connection. Then, the user operates the operator user interface on the user device to accept the request for voice communication to establish a voice communication connection or accept the request for video communication to establish a video communication connection.

The n service devices 30a-30n are connected to the backend device 10, wherein each service device 30a-30n provides a service user interface (not shown). The service user interface can display the question categories and the question information of the user devices 20a-20n transmitted from the service group platform 101. The service user interface can provide checkboxes (not shown) respectively corresponding to the user devices. Each checkbox is used to establish a communication connection between the current service device and the user device corresponding to the checkbox. Thereby, the current service device can respond to the question information provided by the user device corresponding to the checkbox based on the established communication connection.

When the service personnel believe that using other modes of communication connections can help answer the user's questions, each of the service devices 30a-30n can change the communication connection between the service device and the user device that has established the communication connection by operating the service user interface. The communication connection is switched from a text communication mode to a voice communication mode, switched from a text communication mode to a video communication mode, or switched from a voice communication mode to a video communication mode.

The backend device 10 provides the service group platform 101. The service group platform 101 receives the question category and the question information transmitted by each of the user devices 20a-20n. In the present invention, during the communication process between a service device and a user device, if the service personnel operating the service device thinks that it is unable to answer the current user's questions well or needs the assistance of senior personnel, the service personnel can operate the service device to transmit a transfer request 40 to another service device through the service user interface. For example, the service user interface provides a transfer button (not shown). When the service personnel select the transfer button, the service user interface displays a list of service devices that have not yet established a communication connection (not shown) and then the service personnel select another service device on the list of service devices to transmit a transfer request to the foregoing another service device. The list of service devices that have not yet established a communication connection may be provided by the service group platform 101 to the service device.

For example, if the service device 30a and the user device 20a have established a communication connection in FIG. 2 but the service personnel of the service device 30a need the assistance of senior personnel to answer questions, the service device 30a can transmit a transfer request 40 to another service device 30b to ask whether the service device 30b agrees to establish a transfer communication connection with the user device 20a. The transfer communication connection is used to allow the service device 30b to replace the original service device 30a in responding to the question information provided by user device 20a. In another embodiment, the transfer communication connection is used to enable the service device 30b to assist the original service device 30a. Both of the service devices 30a and 30b respond to the question information provided by the user device 20a.

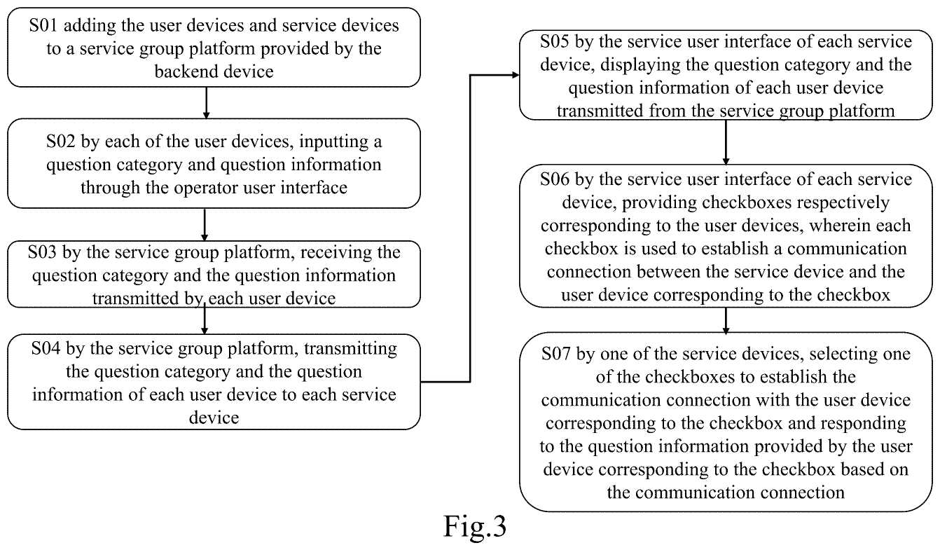

Please refer to FIG. 3. FIG. 3 is a flowchart of a service group platform case assignment method according to a preferred embodiment of the present invention. Please refer to FIGS. 2 and 3 For the following description. The purpose of each device will be described in detail in the flowchart below. It should be understood that the order of the steps in this flowchart can be adaptable and that some steps can be omitted according to different requirements.

Firstly, in Step S01, the user devices 20a-20n and the service devices 30a-30n are added to the service group platform 101, where the service group platform 101 is provided by the backend device 10. In Step S02, each of the user devices 20a-20n inputs a question category and question information through the operator user interface. As mentioned above, the question category can correspond to the service provided by the service provider and the question information is the question inputted by the user. For example, the user inputs a question category about returns through the user interface and the question information inputted asks how to return a product that has just been received because of quality problems? How to refund the payment?

In Step S03, the service group platform 101 receives the question category and question information transmitted by each of the user devices 20a-20n. It should be understood that the question categories and question information transmitted by different user devices 20a-20n usually include different question categories and corresponding question information. Even if the question categories are identical, it is very likely that different question information is asked.

In Step S04, the service group platform 101 transmits the question category and question information of each of the user devices 20a-20n to each of the service devices 30a-30n. In Step S05, the service user interface of each of the service devices 30a-30n displays the question category and question information of each of the user devices 20a-20n transmitted from the service group platform 101.

In Step S06, the service user interface of each of the service devices 30a-30n provides checkboxes respectively corresponding to the user devices. Each checkbox is used to establish a communication connection between the service device and the user device corresponding to the checkbox.

In Step S07, one of the service devices 30a-30n selects one of the checkboxes to establish a communication connection with the user devices corresponding to the checkbox and then responds to the question information provided by the user device corresponding to the checkbox based on the communication connection. For example, in one embodiment, the service user interface of the service device 30a displays the question categories and question information of the user devices 20a-20n and provides checkboxes respectively corresponding to the plurality of user devices 20a-20n. The service personnel of the service device 30a selects the checkbox corresponding to the user device 20a, thereby establishing a communication connection between the service device 30a and the user device 20a. Thus, the service device 30a can respond to the question information provided by the user device 20a based on the communication connection.

In another embodiment of the present invention, the flowchart further includes Step S08 (not shown). In Step S08, one of the service devices operates the service user interface to change the communication connection between the one of the service devices and the user device that has established the communication connection. The communication connection is switched from a text communication mode to a voice communication mode, switched from a text communication mode to a video communication mode, or switched from a voice communication mode to a video communication mode.

In further embodiment of the present invention, the flowchart further includes Step S08 (not shown). In Step S08, one of the service devices operates the service user interface to transmit a transfer request 40 to another of the service devices 30a-30n. The transfer request is used to ask whether the another of the service devices agrees to establish a transfer communication connection with the user device. The transfer communication connection is used to allows the another of the service devices to replace the one of the service devices in responding to the question information provided by the user device.

In yet another embodiment of the present invention, the flowchart further includes Step S08 (not shown). In Step S08, one of the service devices operates the service user interface to transmit a transfer request 40 to another of the service devices 30a-30n. The transfer request is used to ask whether the another of the service devices agrees to establish a transfer communication connection with the user device. The transfer communication connection is used to allows the another of the service devices to assist the one of the service devices in responding to the question information provided by the user device.

According to the forgoing embodiments, it is understood that the present invention increases or decreases the number of service devices. Thus, the present invention provides users with elastic service capacity. Furthermore, since all service devices 30a-30n in the service group can receive the question categories and the question information inputted by all user devices 20a-20n and display them on their service user interfaces, the service personnel of each service device can actively select user devices corresponding to questions that can be answered based on their own abilities and expertise to establish a communication connection, and then respond to questions provided by the user device based on the communication connection. In addition, during the communication process between a service device and a user device, if the service personnel operating the service device think that they are unable to respond to the current user's questions well or need the assistance of senior personnel, the service personnel can operate the service device to transmit a transfer request to another service device through the service user interface. Therefore, another service device can be used to answer the user's questions or another service device can be added to jointly answer the user's questions.

Although various examples of the disclosed technology have been described above, it should be understood that these examples have been presented by examples rather than limited. Likewise, various drawings may depict example architectures or other configurations of the disclosed technology. The drawings may be depicted to assist in understanding the features and functionality that may be included in the disclosed technology. The disclosed technology is not limited to the illustrated example architectures or configurations, but the desired features can be implemented using a variety of alternative architectures and configurations. In fact, it will be obvious to those skilled in the art to know how to implement alternative functionalities, logical or physical partitions and configurations to implement the required features of the technology disclosed in this article. In addition, with regard to flowcharts, operation descriptions, and methodological technical solutions, the order in which the steps are presented herein should not require that the disclosed technologies be implemented in the same order to perform the listed functionality, unless the context dictates otherwise.

What is claimed is:

1. A service group platform case assignment method applied to a service group platform case assignment system that comprises user devices, a backend device, and service devices, each of the user devices providing an operator user interface, each of the service devices providing a service user interface, and the service group platform case assignment method comprising:
Step (A): adding the user devices and service devices to a service group platform provided by the backend device;
Step (B): by each of the user devices, inputting a question category and question information through the operator user interface;
Step (C): by the service group platform, receiving the question category and the question information transmitted by each of the user devices;
Step (D): by the service group platform, transmitting the question category and the question information of each of the user devices to each of the service devices;
Step (E): by the service user interface of each of the service devices, displaying the question category and the question information of each of the user devices transmitted from the service group platform;
Step (F): by the service user interface of each of the service devices, providing checkboxes respectively corresponding to the user devices, wherein each of the checkboxes is used to establish a communication connection between the service device and the user device corresponding to the checkbox; and
Step (G): by one of the service devices, selecting one of the checkboxes to establish the communication connection with the user device corresponding to the checkbox and responding to the question information provided by the user device corresponding to the checkbox based on the communication connection.

2. The service group platform case assignment method according to claim 1, further comprising:
Step (H): by the one of the service devices, operating the service user interface to change the communication connection between the one of the service devices and the user device that has established the communication connection, and the communication connection is switched from a text communication mode to a voice communication mode, switched from a text communication mode to a video communication mode, or switched from a voice communication mode to a video communication mode.

3. The service group platform case assignment method according to claim 1, further comprising:
Step (H): by the one of the service devices, operating the service user interface to transmit a transfer request to another of the service devices, wherein the transfer request is used to ask whether the another of the service devices agrees to establish a transfer communication connection with the user device, and the transfer communication connection is used to allows the another of the service devices to replace the one of the service devices in responding to the question information provided by the user device.

4. The service group platform case assignment method according to claim 1, further comprising:
Step (H): by the one of the service devices, operating the service user interface to transmit a transfer request to another of the service devices, wherein the transfer request is used to ask whether the another of the service devices agrees to establish a transfer communication connection with the user device, and the transfer communication connection is used to allows the another of the service devices to assist the one of the service devices in responding to the question information provided by the user device.

5. A service group platform case assignment system comprising:
user devices each providing an operator user interface that is configured to input a question category and question information;
a backend device, connected to the user devices, providing a service group platform that is configured to receive the question category and the question information transmitted by each of the user devices; and
service devices connected to the backend device;
wherein each of the service devices provides a service user interface, the service user interface of each of the service devices displays the question category and the question information of each of the user devices transmitted from the service group platform, the service user interface of each of the service devices provides checkboxes respectively corresponding to the user devices, and each of the checkboxes is used to establish a communication connection between the service device and the user device corresponding to the checkbox;
wherein one of the service devices selects one of the checkboxes to establish the communication connection with the user device corresponding to the checkbox and responds to the question information provided by the user device corresponding to the checkbox based on the communication connection.

6. The service group platform case assignment system according to claim 5, wherein each of the service devices operates the service user interface to change the communication connection between the service device and the user device that has established the communication connection, and the communication connection is switched from a text communication mode to a voice communication mode, switched from a text communication mode to a video communication mode, or switched from a voice communication mode to a video communication mode.

7. The service group platform case assignment system according to claim 5, wherein the one of the service devices operates the service user interface to transmit a transfer request to another of the service devices, the transfer request is used to ask whether the another of the service devices agrees to establish a transfer communication connection with the user device, and the transfer communication connection is used to allows the another of the service devices to replace the one of the service devices in responding to the question information provided by the user device.

8. The service group platform case assignment system according to claim 5, wherein the one of the service devices operates the service user interface to transmit a transfer request to another of the service devices, the transfer request is used to ask whether the another of the service devices agrees to establish a transfer communication connection with the user device, and the transfer communication connection is used to allows the another of the service devices to assist the one of the service devices in responding to the question information provided by the user device.
